(19) United States
(12) Patent Application Publication
(10) Pub. No.: US 2026/0144244 A1
(43) Pub. Date: May 28, 2026

(54) FISHING HOOK RETENTION APPARATUS

(71) Applicant: Shane Nicholas Felton, Evergreen, CO (US)

(72) Inventor: Shane Nicholas Felton, Evergreen, CO (US)

(21) Appl. No.: 19/397,883

(22) Filed: Nov. 22, 2025

Related U.S. Application Data
(60) Provisional application No. 63/725,546, filed on Nov. 27, 2024.

(51) Int. Cl. A01K 97/06

(52) U.S. Cl. CPC A01K 97/06

(57) ABSTRACT

A fishing hook retention apparatus is disclosed including a retainer plate having a first surface and an opposing second surface. The apparatus positions a plurality of magnets adjacent to the second surface. The first surface includes an array of retention zones. At least one magnet aligns with each retention zone, generating a holding force that extends through the retainer plate. Each retention zone includes an indentation configured with a geometry to receive a body portion of a fishing hook. In an example, the geometry is a channel. In another example, the geometry is a partial sphere. In an example, a rectangular recess is positioned contiguous to and below the partial sphere, configured to receive and laterally constrain the eye portion of the hook. The indentation and the holding force cooperate to secure the fishing hook in a predetermined orientation to enable easy grasping.

### CROSS REFERENCE TO RELATED APPLICATIONS

This application claims the priority benefit of U.S. Provisional Patent Application No. 63/725,546 filed Nov. 27, 2024 for “Fishing Hook Retention Apparatus,” hereby incorporated by reference in its entirety as though fully set forth herein.

### BACKGROUND

Fishing hooks are used by fishermen to catch fish, often as part of a natural or artificial lure. In the sport of fly fishing, the combination of a fishing hook with an artificial lure is referred to as a “fly,” as these lures typically mimic insects. Fly fishermen often collect and maintain numerous flies, which necessitates boxes or other apparatuses for storage and organization.

The current market for boxes and other apparatuses to retain and store flies includes several retention methods. Some methods utilize foam or elastomeric material to retain the fishing hook. These methods require a user to push the hook into slits or other shapes in the foam or elastomeric material to retain the hook. A drawback of this method is that it requires the user to apply force to assist the apparatus with maintaining the hook. Additionally, elastomeric and foam materials, particularly foam, degrade and wear over time as users insert and remove fishing hooks.

Other methods use permanent magnets to retain ferromagnetic fishing hooks. These permanent magnet retention methods also vary. Some systems rely on the fishing hook or other ferromagnetic component of the fly to directly contact a flat magnet. Drawbacks of this method are that fishing hooks are retained in an unorganized manner and can become tangled together. Furthermore, the fishing hooks can wear away thin coatings on the magnets over time, causing the magnets to corrode. Other drawbacks of current permanent magnet retention methods include inappropriate magnetic force, which may be either too strong or too weak. The permanent magnets are often dark in color, failing to provide visual contrast for the flies.

Existing systems attempt to address the issue of disorganization by using magnets in combination with inserts or trays that have indentations or compartments configured to separate individual hooks. While these example devices may prevent hooks from tangling, they still fail to properly orient the hooks for retrieval. The hooks may rest in these indentations in a random orientation, such as lying flat or upside down and/or on top of one another. This lack of specific orientation and separation makes it difficult for a user to easily and safely grasp a single hook by its shank or eye, often requiring the user to awkwardly manipulate the hook to remove it from the container. Therefore, a need exists for an improved apparatus that not only separates and retains fishing hooks but also consistently orients them to enable easy and secure grasping by the user.

### BRIEF DESCRIPTION OF THE DRAWINGS

FIG. 1 illustrates an example fishing hook retention apparatus as it may be implemented to retain a plurality of fishing flies in a first configuration.

FIG. 2 is an isometric view of a retainer plate of the example fishing hook retention apparatus shown in FIG. 1, showing a first surface.

FIG. 3 is an isometric view of a retainer plate of the example fishing hook retention apparatus shown in FIG. 1, showing a second surface with magnets installed therein.

FIG. 4 is a cross-sectional view of the retainer plate of the example fishing hook retention apparatus with magnets installed therein.

FIG. 5 illustrates an example fishing hook retention apparatus as it may be implemented to retain a plurality of fishing flies in a second configuration.

FIG. 6 is an isometric view of a retainer plate of the example fishing hook retention apparatus shown in FIG. 5, showing a second surface with magnets installed therein.

FIG. 7 is an isometric view of a retainer plate of the example fishing hook retention apparatus shown in FIG. 5, showing a first surface.

FIG. 8 is an isometric view showing a cross-section of the retainer plate of the example fishing hook retention apparatus with magnets installed therein.

FIG. 9 is a close-up view corresponding to FIG. 8.

FIG. 10 is another isometric view showing a cross-section of the retainer plate of the example fishing hook retention apparatus with magnets installed therein.

FIG. 11 illustrates an example fishing hook retention apparatus as it may be implemented to retain a plurality of fishing flies in a third configuration.

### DETAILED DESCRIPTION

An example apparatus to retain fishing hooks utilizes permanent magnets and an intermediary component referred to herein as a retainer plate which can be positioned between the permanent magnets and the fishing hooks. The utility of the example apparatus described herein applies not only to retention of fishing hooks, but also to fishing lures and flies that utilize fishing hooks as a primary component. Herein, fishing hooks, flies, and lures may be used interchangeably.

The permanent magnets in the example apparatus provide a holding force against the fishing hooks in the normal direction by introducing magnetic flux to the fishing hook. The retainer plate retains the fishing hooks in lateral directions. The retainer plate uses specially contoured indentations that are configured to retain the geometry of specific ferromagnetic components of the fishing hook. The size and shape of these indentations can vary depending on the size of the fishing hook, fly, or lure they are configured to retain. The retainer plate in the example apparatus remains stationary between the permanent magnets and the fishing hooks.

An example apparatus provides multiple utilities and benefits. Unlike methods that require the fishing hook to directly contact a permanent magnet, the example apparatus helps to organize the fishing hooks by separating each hook from adjacent hooks. It also removes the need for the user to apply force to push the hook into place, which is common in traditional foam or elastomeric material methods. By utilizing both the magnetic field from the permanent magnets and the specific shape of the indentations in the retainer, the apparatus does not require the user to apply considerable force for retention. The user simply places the fishing hook in the correct orientation and position, and the magnetic force pulls the fishing hook into the indentations.

The retainer plate also creates a barrier that protects the permanent magnets from wear and corrosion due to liquid or moisture. The retainer plate may be made of a material that is harder than foam or silicone rubber. Harder materials provide better wear resistance, durability, and longevity than softer materials. The retainer plate material also has a lower coefficient of thermal expansion than foam or silicone rubber, enabling it to maintain its shape better through temperature changes. Furthermore, the user-facing surface of the retainer plate has a relatively low coefficient of friction. This property enables users to easily slide and/or remove fishing hooks or flies.

Some example systems utilize a non-ferrous material for the retainer plate to avoid drawing magnetic flux into the retainer itself. The retainer plate in one example configuration is white in color, which creates visual contrast between the fishing hooks and the retainer.

An example apparatus may use several permanent magnets, and each permanent magnet has two poles. Other example systems may use only one permanent magnet per apparatus to retain several fishing hooks, and other systems may use magnets with multiple poles. The example retention apparatus described herein uses multiple magnets to increase the magnetic field where the fishing hooks are intended for retention and decrease the magnetic field where fishing hooks are not intended for retention. In other words, the apparatus positions the permanent magnets intentionally underneath the indentations of the retainer plate. This configuration retains fishing hooks only in the indentations. The magnetic fields generated by the permanent magnets are strong enough to retain fishing hooks where indentations are located, and the magnetic fields are not strong enough to retain fishing hooks where indentations are not located.

The example apparatus also provides one or more retention zones, each having its own combination of magnet shape and size and indentation shape and size.

In an example retention zone, the apparatus combines rectangular bar magnets with linear slot indentations in the retainer. The linear slots extend the approximate length of the magnetic fields of the rectangular bar magnet. The slot width is slightly wider than the wire diameter of commonly available fishing hooks to hold the fishing hook or hooks relatively snug. This zone provides retention for multiple fishing hooks per magnet, and a user may move fishing hooks along the length of the linear slot indentation.

In another example retention zone, the apparatus combines magnets with a counterbored partial sphere and rectangular indentations in the retainer plate. The partial sphere is just slightly larger than the common eye portion size used for flies, which holds the fishing hook relatively snug therein. The example system places the rectangular indentations inside the same counterbored feature, just below the partial sphere. The rectangular indentation width can be slightly wider than the wire diameter used for the eye of common fishing hooks, which holds the eye relatively snug. This zone retains one fishing hook per magnet. This specific combination of a magnet, a partial sphere indentation for the lure body or bead, and a rectangular indentation for the hook eye securely orients the hook. Specifically, this configuration holds the hook so that its shank points upward, enabling the user to easily and safely grasp the individual hook.

It should be noted that the examples described above are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

Before continuing, it is also noted that as used herein, the terms “includes” and “including” mean, but is not limited to, “includes” or “including” and “includes at least” or “including at least.” The term “based on” means “based on” and “based at least in part on.”

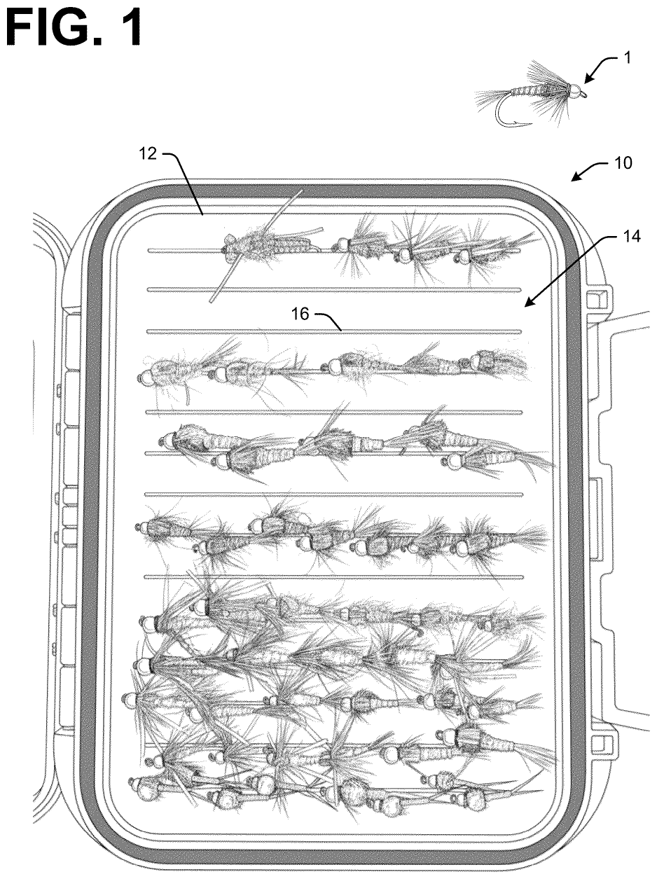

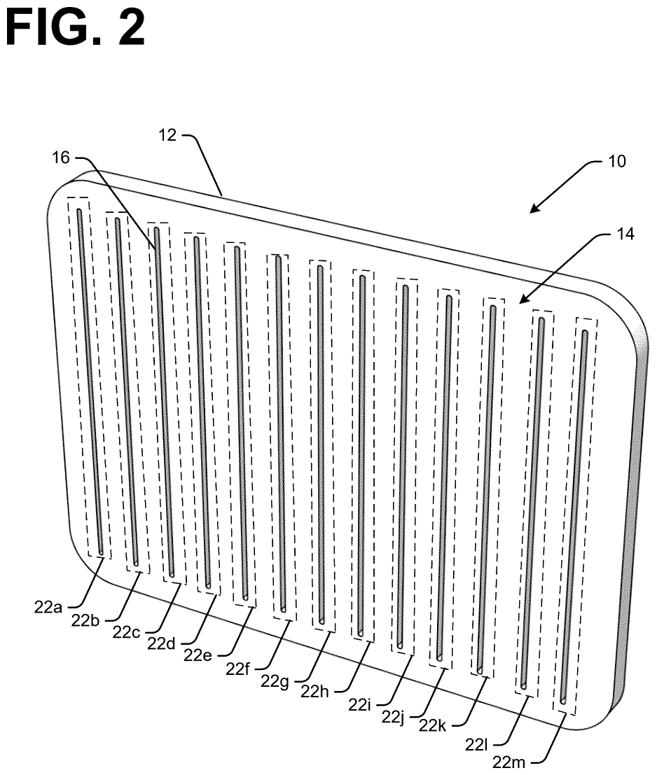

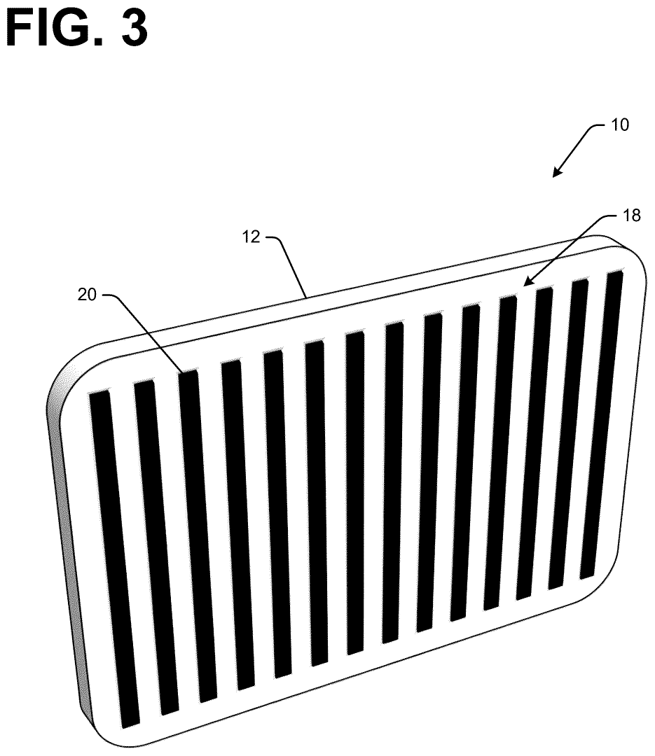

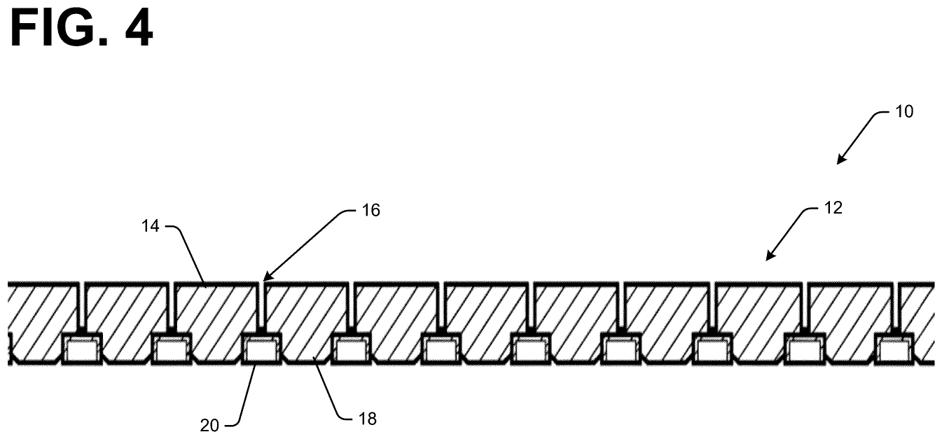

FIG. 1 illustrates an example fishing hook retention apparatus 10 as it may be implemented in a first configuration to retain a plurality of fishing flies (such as fly 1 shown by way of illustration). FIG. 2 is an isometric view of a retainer plate 12 of the example fishing hook retention apparatus 10 shown in FIG. 1, showing a first surface 14 of the retainer plate 12 having indentations 16 configured as channels formed therein. FIG. 3 is an isometric view of the retainer plate 12 of the example fishing hook retention apparatus 10 shown in FIG. 1, showing a second surface 18 of the retainer plate 12 having magnets 20 installed therein. FIG. 4 is a cross-sectional view of the retainer plate 12 of the example fishing hook retention apparatus 10 with the magnets 20 installed therein.

In an example, the fishing hook retention apparatus 10 includes a retainer plate 12, which may be a non-ferrous body such as a plastic insert. The retainer plate 12 can be manufactured from a relatively hard plastic, such as by injection molding or 3D printing. In an example, the retainer plate 12 is made from a non-ferrous and therefore non-ferromagnetic material, such as an injection molded thermoplastic polymer (e.g., ASA or HDPE or UHMW-PE or PTFE) or a CNC-machined material such as aluminum or titanium. Suitable materials can include, by way of nonlimiting examples, ASA (Acrylonitrile Styrene Acrylate), PP (Polypropylene), or HDPE (High-Density Polyethylene), or other plastics having a material hardness in the range of Shore D 50 to Shore D 80. This material choice provides superior durability, wear resistance, and longevity compared to other devices that use softer inserts made of foam (e.g., Shore OO of about 10-60) or silicone (e.g., Shore D of about 5-30), and is lighter than inserts made of aluminum.

The retainer plate 12 includes a first surface 14, for receiving and retaining fishing hooks (such as fly 1 in FIG. 1), and an opposing second surface 18. The retainer plate 12 is stacked on (or the magnets are installed therein) and completely covers the permanent magnets 20 so that the magnets 20 are positioned adjacent to the second surface 18. In an example, the magnets 20 are permanent magnet arrays that utilize rectangular bar magnets. These permanent magnets may be magnetized through thickness, such that only one pole per magnet faces towards the retainer plate. The magnets may also be magnetized through the length or width of the rectangle, axially or diametrically if using cylindrical magnets, or they may be programmable magnets with multiple north and south poles on the same surface.

In an example, the magnets 20 may be press-fit into cavities or recesses formed in the second surface 18 of the retainer plate 12, providing a quick, inexpensive, and clean assembly method. In other embodiments, the magnets 20 may be secured using an adhesive, insert molded directly into, or thermally bonded to the retainer plate 12. The magnets 20 are preferably strong permanent magnets, such as neodymium iron boron (NdFeB) magnets, to provide a high flux density and strong holding force, superior to older ferrite or Alnico type magnets. The magnets 20 are oriented such that the top face of each magnet is theoretically coplanar with all other magnets. In a preferred configuration, the top pole face of the magnets 20 physically contacts the bottom surface of the retainer plate 12. This contact minimizes the distance between the magnets and the fishing hooks, which in one example is between about 0.005 inches and 0.050 inches.

The first surface 14 of the retainer plate 12 includes a plurality of distinct retention zones 22a-m (FIG. 2). These retention zones 22a-m are intentionally and selectively positioned. At least one magnet of the plurality of magnets is aligned with each retention zone 22a-m, for example, by being located on the second surface 18 directly opposite the corresponding zone 22a-m. This alignment is functional, serving to maximize and concentrate the magnetic flux in the retention zones 22a-m while minimizing the magnetic field in areas outside these zones, thereby creating a controlled magnetic field zoning. This alignment generates a holding force that extends through the non-ferrous retainer plate 12 to the first surface 14. Each retention zone 22a-m includes a physical indentation, such as separate indentations 16. This indentation 16 is not merely a flat surface but has a specific three-dimensional geometry such as a channel (e.g., slot, cavity, or groove) formed in the retainer plate 12, that is configured to receive a body portion of a fishing hook (e.g., the point and/or bend). A magnetic field from the aligned magnet 20 exerts a holding force on the ferromagnetic fishing hook. This magnetic holding force and the physical, geometric constraints of the indentation 16 cooperate to secure the fishing hook in a specific, stable, predetermined orientation. For example, this orientation may hold the hook with the eye pointing up off of the first surface 14, allowing a user to grasp the hook and thread a fishing line or tippet through the eye without needing to re-grip or reposition the hook.

In an example, the indentation geometry of one or more of the retention zones 22a-m may comprise at least one channel. This channel, which may also be described as a slot, cavity, or groove, is specifically configured to receive and physically constrain a body portion of the fishing hook. In one embodiment, the purpose of the shape of the channel is to retain the bend and point portion of a fishing hook, with the hook point being the closest part to the underlying bar magnets.

In an example, the channel may have a specific width, for example, a width between approximately 0.010 inches and 0.130 inches. A more preferred range may be between 0.015 inches and 0.100 inches, to accommodate a wide variety of hook sizes from very small (e.g., size 26) to very large (e.g., #4/0). A specific embodiment includes a slot width between 0.016 inches and 0.040 inches. The channel may also have a depth between 0.060 inches and 0.150 inches. This width is just wide enough to hold the metallic hook portion (e.g., the bend and point) while the remainder of the fly (such as the shank, bead, hackle, or feathers) sits outside or above the channel, distinguishing it from prior art grooves that are sized to contain the entire fly body. In an example, a single channel or slot of this type may be configured to receive and hold multiple fishing hooks, which may be arranged in a row within the slot.

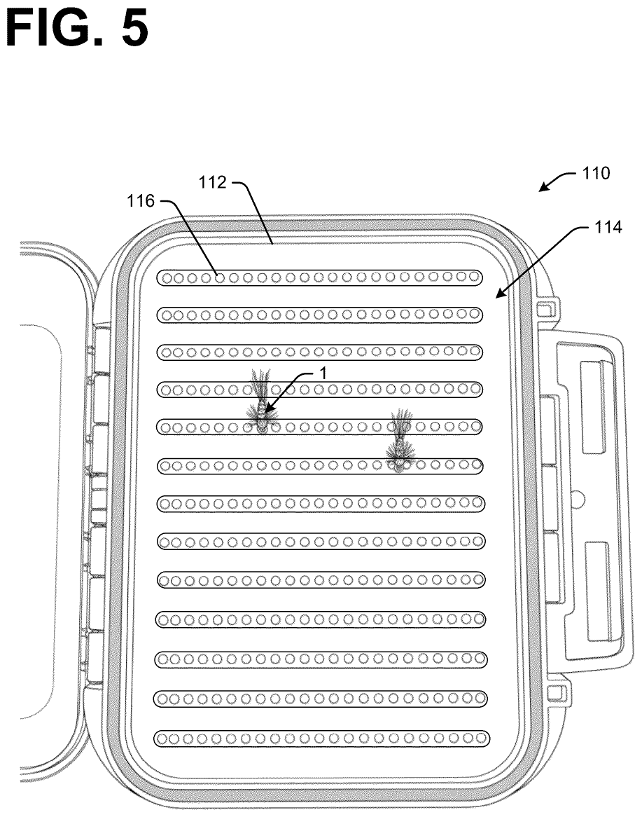

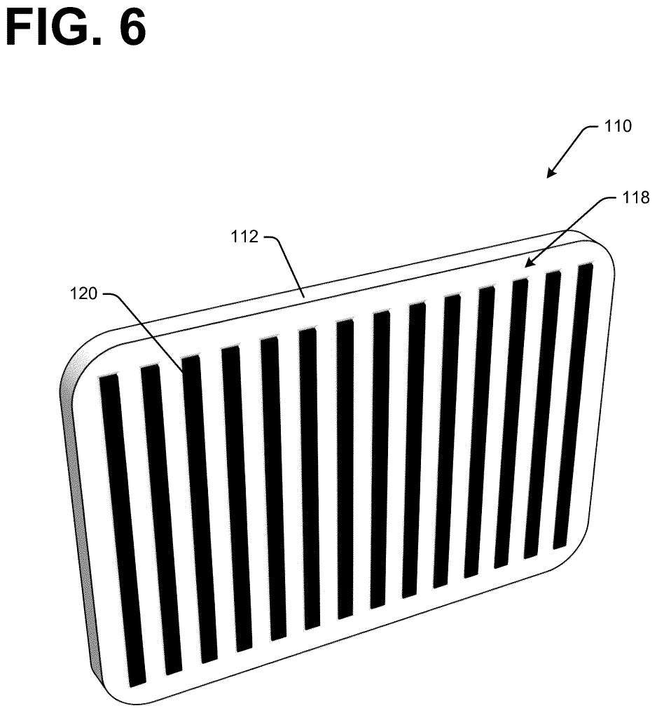

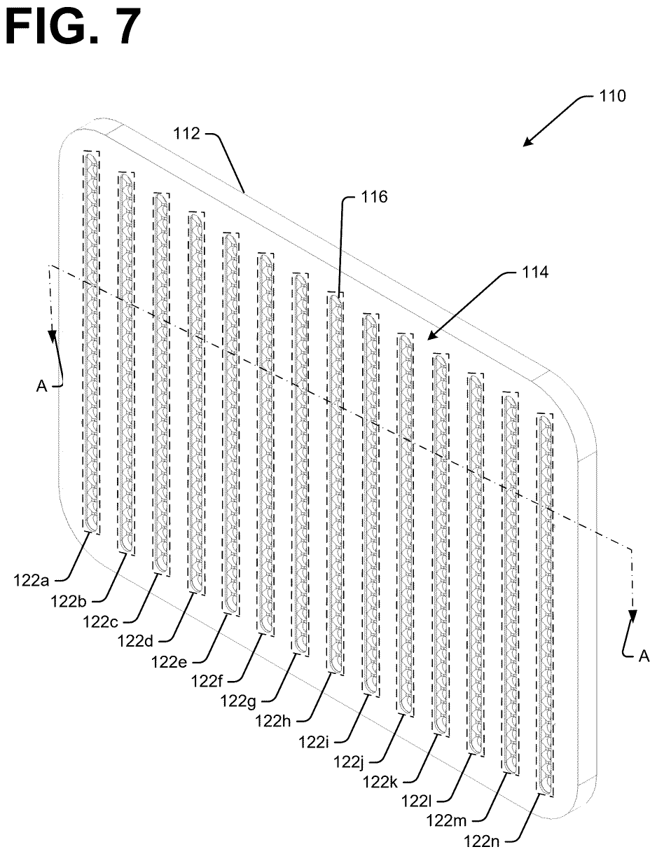

FIG. 5 illustrates another example of a fishing hook retention apparatus 110 as it may be implemented to retain a plurality of fishing flies in a second configuration. FIG. 6 is an isometric view of a retainer plate 112 of the example fishing hook retention apparatus 110 shown in FIG. 5, showing a second surface 118 with magnets 120 installed therein. FIG. 7 is an isometric view of a retainer plate 112 of the example fishing hook retention apparatus 110 shown in FIG. 5, showing a first surface 114 of the retainer plate 112. It is noted that 100-series reference numbers are used to refer to similar components as already described above with reference to the fishing hook retention apparatus 10 shown in FIGS. 1-4.

In an example, the fishing hook retention apparatus 110 includes a retainer plate 112, which may be a non-ferrous body such as a plastic insert. This retainer plate 112 may be manufactured from a relatively hard plastic, for example, by injection molding or 3D printing. Suitable materials and manufacturing has already been described above for the fishing hook retention apparatus 10 shown in FIGS. 1-4 and thus is not repeated here.

The retainer plate 112 includes a first surface 114, for receiving and retaining fishing hooks (flies), and an opposing second surface 118, and is configured to cover (but not necessarily encase) the magnets 120. The magnets 120 are positioned adjacent to the second surface 118. Again, the magnets 120 may include rectangular bar magnet arrays, which are magnetized through thickness so one pole faces the retainer. In an example, these magnets can be press-fit into cavities or recesses formed in the second surface 118 of the retainer plate 112. In another example, the magnets 120 can be secured using an adhesive or other fastening means. Again, the magnets 120 are preferably strong permanent magnets, such as rare-earth magnets, and more preferably neodymium iron boron (NdFeB) magnets. As noted above, these magnets provide a high flux density and strong holding force, superior to older ferrite or Alnico type magnets. The magnets may be shapes other than rectangular, such as cylindrical, spherical, or ring-shaped. Additional components such as shunt plates or flux guides may be added to the apparatus to aid in strengthening the magnetic flux and focusing the magnetic field towards the flies.

The first surface 114 of the retainer plate 112 includes a plurality of retention zones 122a-n. These retention zones are intentionally and selectively positioned. For example, at least one magnet 120 of the plurality of magnets is aligned with each retention zone 122a-n, for example, by being located on the second surface 118 directly opposite or in close proximity to the corresponding retention zone 122a-n. This specific alignment is functional, serving to maximize and concentrate the magnetic flux in the retention zones 122a-n while minimizing the magnetic field in areas outside these retention zones 122a-n. This configuration creates a controlled magnetic field zoning for optimal hook retention. This alignment generates a holding force that extends through the non-ferrous retainer plate 112 to the first surface 114 where the hooks are held.

Each retention zone 122a-n includes a physical indentation 116, such as a circular or partial spherical recess. It is noted that other examples may utilize different geometry, and even protrusions in the retainer plate 112. The indentation 116 is not merely a flat surface but has a specific three-dimensional geometry configured to receive one or multiple body portions of a fishing hook (e.g., the shank, bend, point, or eye).

A magnetic field from the aligned magnet 120 exerts a holding force on the ferromagnetic portion of the fishing hook. This magnetic holding force and the physical, geometric constraints of the indentation 116 cooperate to secure the fishing hook in a specific, predetermined orientation. This predetermined orientation is advantageous, as it may, for example, hold the hook with the eye pointing upwards, allowing a user to easily grasp the hook and thread a fishing line or tippet through the eye without needing to re-grip or reposition the hook.

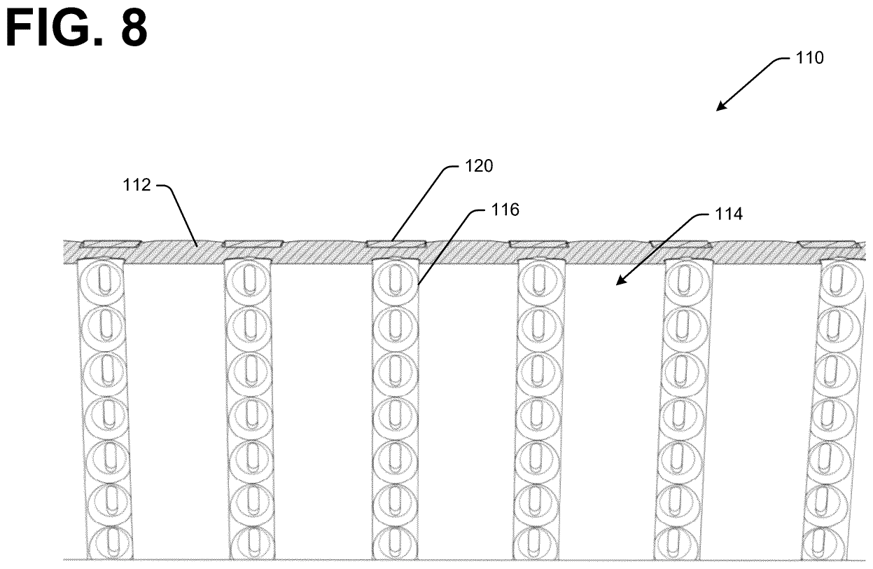

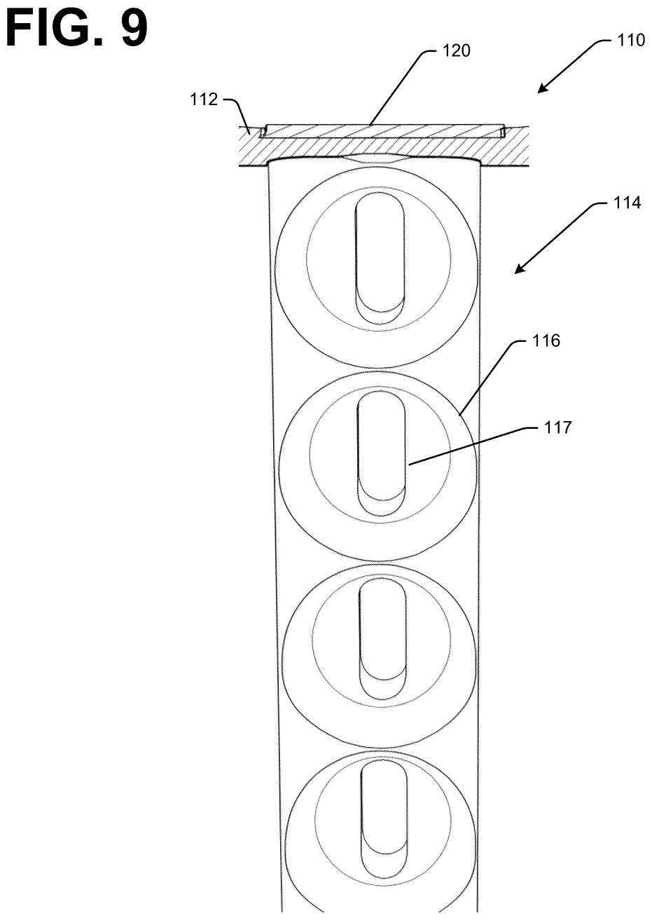

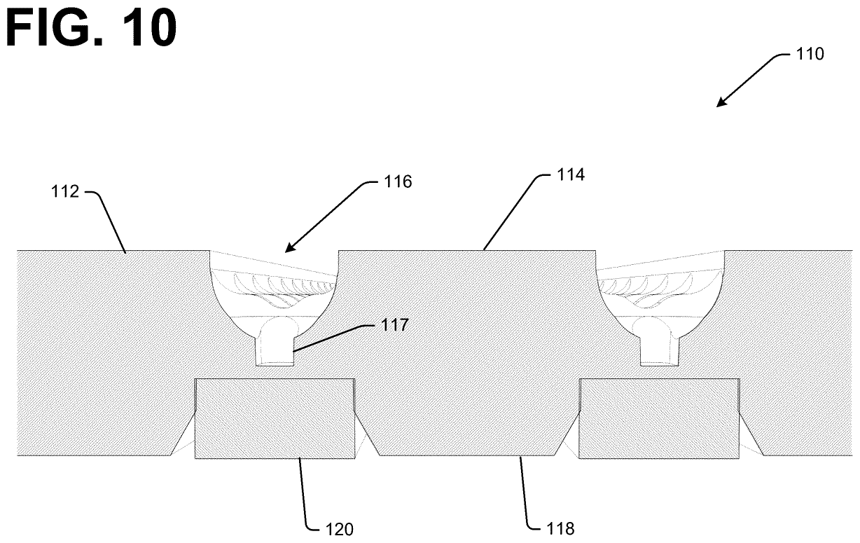

FIG. 8 is an isometric view showing a cross-section (taken along line A-A in FIG. 7) of the retainer plate 112 of the example fishing hook retention apparatus 110 with magnets 120 installed therein. FIG. 9 is a close-up view corresponding to FIG. 8. FIG. 10 is another isometric view showing a cross-section of the retainer plate 112 of the example fishing hook retention apparatus 110 with magnets installed therein.

As an aspect of the apparatus, the geometry of the indentation of at least one of the retention zones (such as a circular indentation zone 42) may comprise a circular or partial sphere shape. This shape is specifically configured to receive a rounded portion of the fishing hook or fly, such as the bead of the fly, which is often located adjacent to the eye of the hook. This type of indentation 116 is particularly well-suited for holding a single hook, especially small fishing hooks, size 14 and smaller. In an example, this partially spherical indentation 116 may have a primary diameter, for example, between approximately 0.050 inches and 0.22 inches, which is sized to accommodate a typical bead on a fly. An example specifies this diameter is between 0.060 inches and 0.125 inches.

The indentation 116, as seen in FIGS. 8-11 can further include a narrower, groove or slot-like portion located within the circular shape of the partially spherical portion of the indentation 116, such as one or more rectangular recesses 117. This narrower portion may have a width, for example, between approximately 0.010 inches and 0.130 inches, and is specifically sized to receive and hold the eye of the hook itself.

The cooperation of this specific geometry (the partial sphere for the bead and/or the slot for the eye) and the magnetic force from the underlying magnet 120 serves to orient the hook in a unique and highly beneficial manner. Specifically, it holds the hook (fly) such that the shank of the fishing hook extends generally upward and away from the first surface of the retainer plate, while the bend of the hook is exposed to the user. This predetermined, “bendup” orientation is a significant functional advantage, as it presents the hook to the user in a ready-to-use position. This enables the user to grasp the hook end and thread a fishing line (tippet) directly through the eye of the hook without needing to first pick up the hook and subsequently adjust their grip to find and thread the eye.

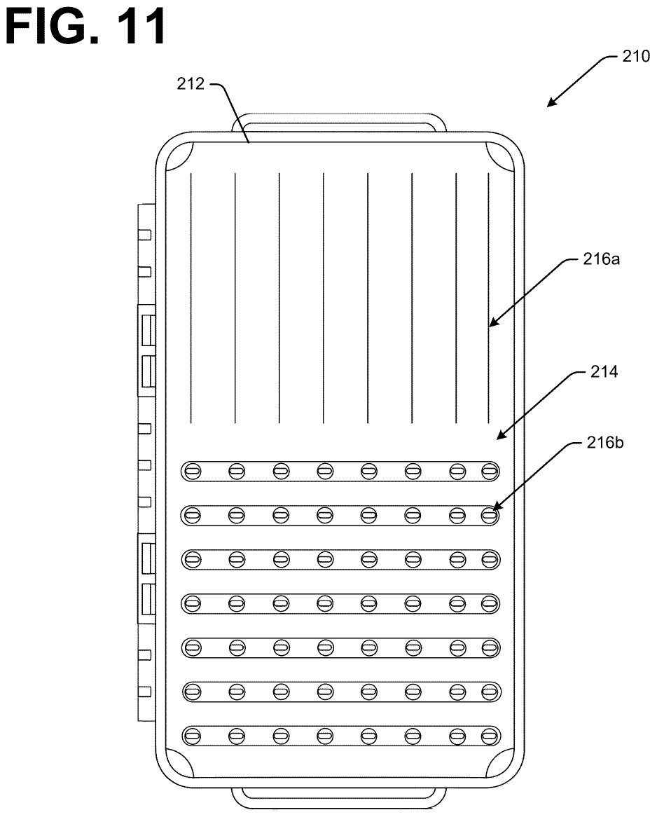

FIG. 11 illustrates an example fishing hook retention apparatus 210 as it may be implemented to retain a plurality of fishing flies in a third configuration. It is noted that 200-series reference numbers are used to refer to similar components as already described above with reference to the fishing hook retention apparatus 10 shown in FIGS. 1-4 and the fishing hook retention apparatus 110 shown in FIGS. 5-11.

In this example, the fishing hook retention apparatus 210 is provided with a retainer plate 212, which may be a non-ferrous body such as a plastic insert. The retainer plate 212 includes a first surface 214, for receiving and retaining fishing hooks (flies), and an opposing second surface 218. A plurality of magnets 220 are positioned adjacent to this second surface 218. These magnets 220 may include bar arrays and are magnetized through thickness. In some embodiments, the top faces of the magnets 220 contact the bottom surface 218 of the retainer plate 212. In an example, these magnets 220 may be press-fit into cavities or recesses on the second or bottom surface 218 of the retainer plate 212, providing a quick and clean assembly method. In another example, the magnets 220 may be secured using an adhesive.

The apparatus 210 may include multiple types of retention zones on the same retainer plate 212, each with a different indentation geometry tailored for different purposes, hook types, or hook sizes. For example, a first of the plurality of retention zones may feature an indentation geometry in the form of a channel or slot (channel indentations 216a). As described above already for apparatus 10, the channel is configured to receive and physically constrain a portion of the fishing hook, such as the bend and point. The width is specifically designed to hold the hook portion itself, while the rest of the fly (e.g., bead, hackle, feathers) rests above or outside the slot. Such a slot-shaped retention zone may be configured to hold a single hook or, in some embodiments, multiple hooks per slot.

The apparatus 210 may also include a second of the plurality of retention zones, which has a different geometry (partially spherical indentations 216b). The second geometry may be a circular indentation or a partial sphere shape. As described above already for apparatus 110, this shape is specifically configured to receive the eye portion of the fishing hook, or a bead commonly found adjacent to the eye on many fly patterns, such as those on size 14 or smaller flies. This circular indentation may be specifically sized to receive and hold the eye of the hook itself. As previously noted, this configuration, in cooperation with the magnetic force, holds the hook (e.g., a single hook per indentation) in a predetermined, “eye-up” orientation for easy access by the user.

Magnets within the apparatus 210 are selectively positioned to maximize the magnetic flux within the designated fishing hook (fly) retention zones, and to minimize the magnetic flux outside of these zones. This configuration creates intentional zoning, which is an important differentiator from the prior art.

It is noted that still other examples are also contemplated as being within the scope of the disclosure, as will be readily understood by those having ordinary skill in the art after becoming familiar with the teachings herein. The scope of the claims is not intended to be limited to these examples.

It is further noted that the invention described herein differs from other magnetic boxes, which typically utilize flat surfaces with larger magnets placed behind them. An important improvement is the use of controlled zoning, contrasting with the incidental field effects found in other products. Other embodiments may also utilize a magnetic shunt as an additional component to reduce magnetic flux leakage outside of the apparatus.

Another aspect of the invention is its unique hook organization system, which relies on the specific geometry of indentations in a plastic insert. The apparatus organizes hooks within dedicated indentations. These indentations are specifically sized and shaped to correspond to hook geometry. The slots are designed to hold multiple hooks in each slot. The apparatus also features circular indentations, each designed to hold one hook. A unique feature of the invention's circular indentations is that these are configured to hold the eye portion of the hook. This orientation causes the hook to point upward, facilitating an easier user experience. It allows the user to grab the hook end and thread the fishing line (tippet) through the eye without needing to adjust their grip on the fly.

Specific geometric dimensions for these indentations are also contemplated. For the slot geometry, the width is designed to hold only the hook portion of the fishing hook or fly. The remaining parts of the fly, such as the bead, hackle, or feathers, sit outside or above the slot. The slot width can be between 0.010 inches and 0.130 inches. This range accommodates small flies (e.g., size 26) as well as larger flies (e.g., #4/0 streamer). A narrower range of 0.015 inches to 0.100 inches is also contemplated. One specific embodiment utilizes a slot width between 0.016 inches and 0.040 inches and a slot depth between 0.060 inches and 0.150 inches. For the circular indentation geometry, the diameter is specified between 0.050 inches and 0.22 inches. This diameter is designed to hold the bead that is adjacent to the eye portion of the fishing hook. A specific embodiment utilizes a diameter between 0.060 inches and 0.125 inches. Within this circular area, an indentation intended to hold the eye of the hook has a width identical to the slot width, namely 0.010 inches to 0.130 inches. While these dimensional ranges are specified, the scope of the invention is only to be limited by the specific claim recitations.

Further distinguishing features relate to the retaining plate configured as a plastic insert. In an example, the plastic insert is made from injection-molded or 3D-printed plastic. It is characterized as a relatively hard plastic, which sets it apart from other fly box inserts made of foam, silicone, or aluminum. Materials of manufacture include polymers including, but not limited to: ASA, PP, HDPE, UHMW-PE, PTFE or non-ferrous metals such as aluminum or titanium. ASA is a likely material, though the invention is not intended to be limited other than as specified in the claims. A quantitative metric for this hardness is a Shore D rating between about 50 and 80. For comparison, ASA is Shore D of about 70-75, PP is Shore D of about 65-75, and HDPE is Shore D of about 55-70. These are significantly harder than silicone (Shore A of about 30-80 or Shore D of about 5-30) or flexible foam (Shore OO of about 10-60). This harder plastic provides benefits including better durability, wear resistance and longevity. It is also lighter in weight than aluminum, which is noted as being far harder (Rockwell B of about 60).

It is noted that the apparatus described herein can be manufactured via injection molding, compression molding, stamping, water jetting, die cutting, laser cutting, urethane casting, silicone casting, metal casting, overmolding, or composites manufacturing.

In some configurations, a separate magnet holder component may be integrated into the apparatus to maintain the position of the magnets, or the magnets may be embedded directly into the retainer without a separate holder.

In some embodiments, the fishing hook retention apparatus is installed into a container. This container may include a bottom enclosure with an internal cavity, a top cover, and a hinge shaft. The top cover, in some embodiments, is made from a transparent material so the user can see the fishing hooks when the container is closed. The apparatus may be permanently installed into the bottom enclosure and hermetically sealed using a sealant. This sealing prevents liquid from contacting the permanent magnets, which would cause corrosion. The container may also utilize mating permanent magnets to hold the bottom enclosure and top cover together in a closed state.

The detailed descriptions of this invention thus far have described the preferred embodiment. Alternative embodiments are intended to be included in the scope of this invention. While this invention was designed to provide utility for retaining fly lures for fly fishing, other embodiments may be utilized for retaining other types of lures for other forms of fishing, such as but not limited to: jigs, spoons, spinnerbaits, or standalone hooks. Other various alterations can be made to the invention, and all alterations are intended to fall within the scope of the invention.

It is noted that the examples shown and described are provided for purposes of illustration and are not intended to be limiting. Still other examples are also contemplated.

1. A fishing hook retention apparatus, comprising:
at least one retainer plate having a first surface and an opposing second surface;
at least one magnet positioned adjacent to the second surface of the retainer plate; and
at least one retention zone located on the first surface;
wherein at least one magnet is aligned with each retention zone to generate a magnetic field that extends through the first surface and into each retention zone;
wherein each retention zone includes at least one indentation having a geometry configured to receive a portion of a fishing hook; and
wherein the magnetic field exerts a holding force on the fishing hook, and wherein the indentation and the magnetic field cooperate to secure the fishing hook in a predetermined orientation without requiring insertion of the hook into a compressible material.

2. The apparatus of claim 1, wherein the geometry of the indentation comprises a partial sphere shape configured to receive a bead portion of a fly of the fishing hook, wherein a shank of the fishing hook extends generally upward and away from the first surface of the retainer plate to enable grasping by a user's fingers.

3. The apparatus of claim 1, wherein the geometry of the indentation comprises at least one channel configured to receive and constrain the bend and point portion of the fishing hook.

4. The apparatus of claim 1, wherein the geometry of the indentation of a retention zone comprises at least one channel configured to receive and constrain the bend and point portion of the fishing hook, and the geometry of the indentation of a second retention zone comprises at least one partial sphere shape configured to receive the eye portion of the fishing hook.

5. The apparatus of claim 1, wherein the indentation of the retention zone comprises a counterbored partial sphere geometry configured to receive and conform to a bead portion of a body of a fly of the fishing hook.

6. The apparatus of claim 5, wherein the indentation of the retention zone comprises a rectangular recess geometry positioned contiguous to and below the partial sphere geometry, the rectangular recess configured to receive and laterally constrain the eye of the hook.

7. The apparatus of claim 1, wherein the second surface contains at least one magnet-receiving recess, each recess aligned with a corresponding retention zone on the first surface.

8. The apparatus of claim 1, wherein the at least one magnet aligned with the retention zone is shaped as a rectangular prism.

9. The apparatus of claim 1, wherein the retainer plate comprises a non-ferrous material.

10. The apparatus of claim 9, wherein the non-ferrous material is a thermoplastic polymer.

11. The apparatus of claim 1, wherein the magnet or plurality of magnets physically contact the second surface of the retainer plate.

12. The apparatus of claim 1, further comprising a magnet holder adjacent to the second surface, the magnet holder including cavities configured to maintain the position of the magnet or plurality of magnets.

13. The apparatus of claim 1, further comprising a second retention zone on the first surface, the second retention zone including a linear slot indentation.

14. The apparatus of claim 13, wherein the second retention zone is aligned with at least one rectangular bar magnet positioned adjacent to the second surface.

15. The apparatus of claim 13, wherein the linear slot indentation is configured to align the fishing hook by a bend portion of the fishing hook.

16. A fishing hook retention apparatus, comprising:
a non-ferrous retainer plate defining a top retention surface and an opposing bottom surface;
a plurality of magnets positioned adjacent to the bottom surface; and
a plurality of retention indentations formed in the top retention surface, each of the plurality of retention indentations aligned with at least one of the magnets;
wherein each of the plurality of retention indentations comprise:
a counterbored partial sphere geometry configured to receive and conform to a body portion of a fishing hook; and
a rectangular recess geometry positioned contiguous to and below the partial sphere geometry, configured to receive and laterally constrain an eye portion of the fishing hook;
wherein the plurality of magnets generates at least one magnetic field sufficient to pass through the retainer plate and attract the eye portion of the fishing hook into the rectangular recess;
whereby the combination of the body portion being seated in the partial sphere geometry and the eye portion being magnetically held within the rectangular recess geometry secures the fishing hook in a stable, predetermined orientation, the predetermined orientation presenting a shank portion of the fishing hook in a generally upward direction away from the top retention surface to facilitate a user grasping the fishing hook.

17. The apparatus of claim 16, wherein the retention indentation does not extend completely through the retainer plate, thereby forming a blind indentation defined by a depth less than a total thickness of the retainer plate.

18. The apparatus of claim 16, wherein the bottom surface contains at least one magnet-receiving recess, each recess aligned with a corresponding retention indentation on the top retention surface.

19. The apparatus of claim 18, wherein at least one magnet is press-fit or interference-fit into each recess to establish mechanical retention without adhesives.

20. The apparatus of claim 18, wherein at least one magnet is insert-molded, adhesively bonded, or thermally bonded within the retainer plate.
